(19) United States
(12) Patent Application Publication
(10) Pub. No.: US 2019/0218925 A1
(43) Pub. Date: Jul. 18, 2019

(54) TURBINE ENGINE SHROUD

(71) Applicant: GENERAL ELECTRIC COMPANY, Schenectady, NY (US)

(72) Inventors: Gregory Terrence Garay, West Chester, OH (US); Aaron Ezekiel Smith, Hermosa Beach, CA (US); Daniel Lee Durstock, Fort Wright, KY (US)

(21) Appl. No.: 15/874,337

(22) Filed: Jan. 18, 2018

(51) Int. Cl. F01D 9/06; F01D 25/12; F01D 25/14

(52) U.S. Cl. CPC F01D 9/065; F01D 25/12; F05D 2240/10; F05D 2260/201; F05D 2220/3215; F01D 25/14

(57) ABSTRACT

A shroud for a turbine engine includes a body having a first surface with an inlet fluidly coupled to a cooling fluid flow, and a second surface facing a heated fluid flow. A cavity within the body can be fluidly coupled to the inlet and include an impingement zone thermally coupled to the second surface.

### BACKGROUND

Turbine engines, and particularly gas or combustion turbine engines, are rotary engines that extract energy from a flow of combusted gases passing through the engine onto a multitude of rotating turbine blades.

Turbine engines are often designed to operate at high temperatures to improve engine efficiency. It is beneficial to provide cooling measures for components such as airfoils in the high-temperature environment, where such cooling measures can reduce material wear on these components and provide for increased structural stability during engine operation.

The cooling measures can include bleed air from the compressor that is routed to the desired location in the engine. The bleed air can be utilized to provide purge air flow at specific component interfaces. Optimizing bleed air delivery and coverage further helps to improve the engine efficiency.

### BRIEF DESCRIPTION

In one aspect, the disclosure relates to a shroud for a turbine engine including a body having a first edge, a second edge, a first surface with an inlet fluidly coupled to a cooling fluid flow, and a second surface spaced radially inward from the first surface and facing a heated fluid flow, a first cavity within the body fluidly coupled to the inlet and having a first impingement zone thermally coupled to the second surface, a second cavity within the body fluidly coupled to the first cavity and having a second impingement zone thermally coupled to the second surface, a cooling passage fluidly coupling one of the first and second cavities to the second surface, and a discharge passage fluidly coupling one of the first and second cavities to one of the first edge and second edge.

In another aspect, the disclosure relates to a shroud and hanger assembly for a turbine engine. The shroud and hanger assembly includes a hanger comprising a hanger cooling circuit with a circuit inlet and a circuit outlet, the circuit inlet being fluidly coupled to a cooling fluid flow. The shroud and hanger assembly also includes a shroud having a body having a first edge, a second edge, a first surface with an inlet fluidly coupled to the circuit outlet, and a second surface spaced radially inward from the first surface and facing a heated fluid flow, a first cavity within the body fluidly coupled to the inlet and having a first impingement zone thermally coupled to the second surface, a second cavity within the body fluidly coupled to the first cavity and having a second impingement zone thermally coupled to the second surface, a cooling passage fluidly coupling one of the first and second cavities to the second surface, and a discharge passage fluidly coupling one of the first and second cavities to one of the first edge and second edge.

In yet another aspect, the disclosure relates to a turbine engine including a compressor section, a combustor, and a turbine section in axial flow arrangement, at least one of the compressor section or the turbine section comprising an airfoil assembly including a shroud. The shroud includes a body having a first edge, a second edge, a first surface with an inlet fluidly coupled to a cooling fluid flow, and a second surface spaced radially inward from the first surface and facing a heated fluid flow, a first cavity within the body fluidly coupled to the inlet and having a first impingement zone thermally coupled to the second surface, a second cavity within the body fluidly coupled to the first cavity and having a second impingement zone thermally coupled to the second surface, a cooling passage fluidly coupling one of the first and second cavities to the second surface, and a discharge passage fluidly coupling one of the first and second cavities to one of the first edge and second edge.

In still another aspect, the disclosure relates to a method of purging a leakage flow in a turbine engine including a shroud including a body having a first surface with an inlet fluidly coupled to a cooling fluid source and a heated second surface facing a heated fluid flow. The method includes serially flowing cooling air through multiple impingement cavities adjacent the heated second surface, and exhausting at least some of the cooling air from the impingement cavities to purge a leakage flow along an edge of the body.

### BRIEF DESCRIPTION OF THE DRAWINGS

In the drawings:

FIG. 1 is a schematic cross-sectional diagram of a turbine engine for an aircraft.

FIG. 2 is an enlarged view of a low pressure turbine section of the turbine engine from FIG. 1 including a shroud in accordance with various aspects described herein.

FIG. 3 illustrates cooling passages which can be utilized in the shroud of FIG. 2.

FIG. 4 illustrates diffusers which can be utilized in the cooling passages of FIG. 3.

FIG. 5 illustrates another shroud which can be utilized in the turbine engine of FIG. 1.

### DETAILED DESCRIPTION OF THE INVENTION

Aspects of the disclosure described herein are directed to a shroud within a turbine engine. For purposes of illustration, the present disclosure will be described with respect to the turbine section of a turbine engine. It will be understood, however, that aspects of the disclosure described herein are not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine or being relatively closer to the engine outlet as compared to another component.

Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

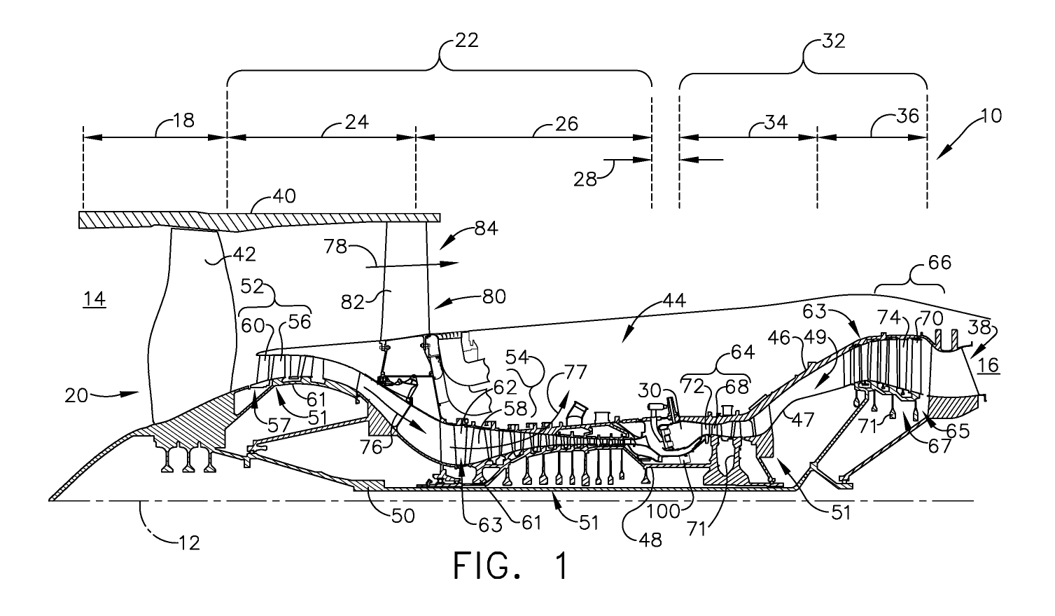

FIG. 1 is a schematic cross-sectional diagram of a turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by outer casing 46, which can be coupled with the fan casing 40. An inner casing 47 is located within the outer casing 46 and together the inner casing 47 and outer casing 46 define an annular channel 49 through which the combustion gases can flow.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54 having a blade assemblies 55 and a vane assemblies 57. Each blade assembly 55 includes a set of compressor blades 56, 58 that rotate relative to each vane assembly 57 having a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor can be mounted to a disk 61, which is mounted to the corresponding one of the HP and LP spools 48, 50, with each stage having its own disk 61. The vanes 60, 62 for a stage of the compressor can be mounted to the outer casing 46 in a circumferential arrangement.

The HP turbine 34 and the LP turbine 36 respectively include a plurality of turbine stages 64, 66, having blade assemblies 65 and a vane assemblies 67. Each blade assembly 65 includes a set of turbine blades 68, 70 that rotate relative to each vane assembly 67 having a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can be mounted to a disk 71, which is mounted to the corresponding one of the HP and LP spools 48, 50, with each stage having a dedicated disk 71. The vanes 72, 74 for a stage of the turbine can be mounted to the outer casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 is split such that a portion of the airflow is channeled into the LP compressor 24, which then supplies pressurized air 76 to the HP compressor 26, which further pressurizes the air. The pressurized air 76 from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine assembly 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

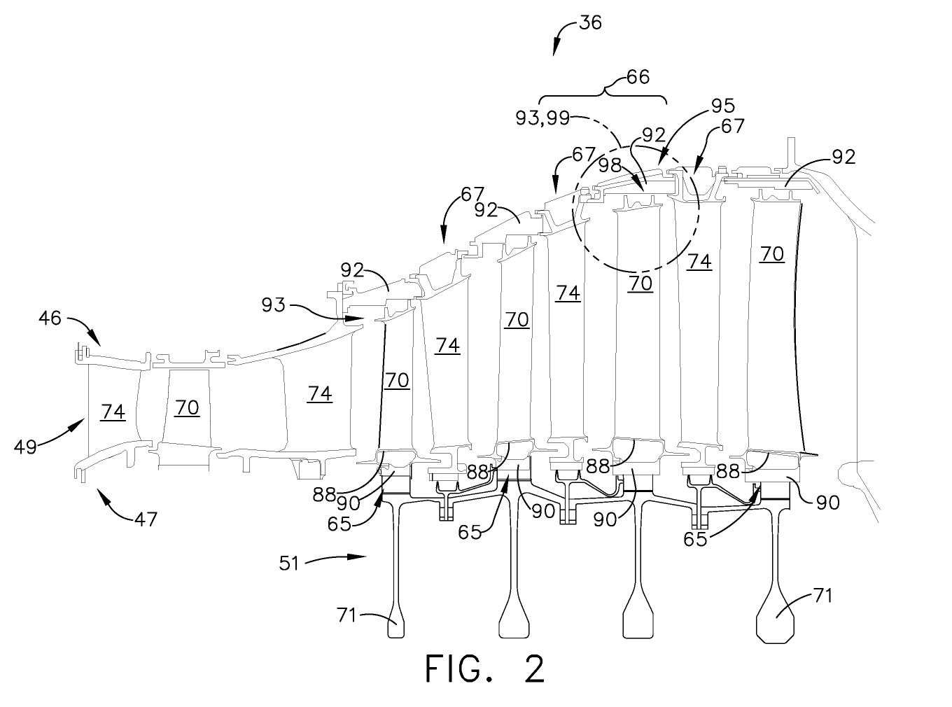

FIG. 2 is an enlarged view of a portion FIG. 1 more clearly illustrating half of the annular channel 49 at the LP turbine 36. The LP turbine 36 can include multiple turbine stages 66. Each turbine stage 66 can include pairs of airfoil assemblies 99, and is illustrated as including the exemplary blade and vane assemblies 65, 67. The blade and vane assemblies 65, 67 are provided within the annular channel 49 such that the consecutive blade and vane assemblies 65, 67 fill the annular channel 49 with circumferentially arranged blades 70 and vanes 74 through which the flow of combustion gases can move. It should be understood that while an LP turbine 36 is illustrated, aspects of the disclosure discussed herein are not limited to the LP turbine 36 and can be applied to other areas of the engine including to the compressor section 22 and the HP turbine 34.

The blade assemblies 65 can include the blades 70 mounted to blade platforms 88 and extending radially out from dovetails 90. The dovetails 90 are mounted to the disk 71, which are collectively connected to form the rotor 51. A plurality of circumferentially arranged shroud segments 92 can surround the blades 70, and at least one of the shroud segments 92 can include a hanger 95 and shroud 98 which together define a shroud and hanger assembly 93. In this manner, at least one of the compressor section 22 or the turbine section 32 can include the stage 66 having an airfoil assembly 99 including a shroud 98. Furthermore, it should be understood that aspects of the shroud 98 described herein can be utilized with any airfoil assembly 99 within the turbine engine 10, including any rotating or non-rotating airfoil assembly 99 such as the vane assembly 67 or blade assembly 65.

The LP turbine 36 is illustrated in the example of FIG. 2 as including at least one stage 66 as described above. It should be understood that the LP turbine 36 can include more or fewer stages than illustrated, and that the stages are for illustrative purposes only.

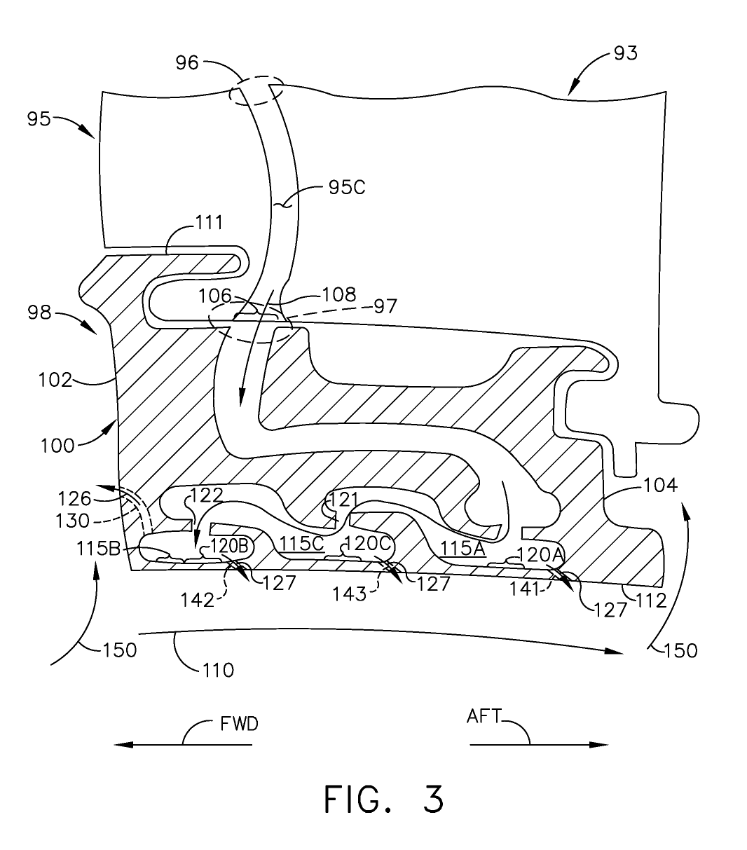

Turning to FIG. 3, the stage 66 is enlarged to more clearly illustrate the exemplary shroud and hanger assembly 93 which can be utilized in the turbine engine 10.

The hanger 95 can include a hanger cooling circuit 95C having a circuit outlet 97 as well as a circuit inlet 96 fluidly coupled to a cooling fluid flow 108. The shroud 98 can include a body 100 with a first edge 102 forming a fore edge 102, a second edge 104 forming an aft edge 104, a first surface 111 with an inlet 106 fluidly coupled to the circuit outlet 97. It is contemplated that the hanger cooling circuit 95C can be a dedicated supply of cooling air for the shroud 98, where other cooling passages or channels not illustrated can be formed in the hanger 95. It can be appreciated that the inlet 106 of the shroud 98 can also be fluidly coupled to the cooling fluid flow 108, either directly or by way of an intervening component such as the hanger cooling circuit 95C, in non-limiting examples, A second surface 112 can be spaced radially inward from the first surface 111 and face a heated fluid flow 110. It should be understood that the first edge 102 and second edge 104, while illustrated as a fore edge 102 and an aft edge 104, can include any edge of the body 100 including a circumferential edge as desired.

The body 100 of the shroud 98 can include cavities or portions to direct the cooling fluid flow. A first cavity 115A can be fluidly coupled to the inlet 106 and include a first impingement zone 120A thermally coupled to the second surface 112. A second cavity 115B within the body 100 can be fluidly coupled to, and located forward of, the first cavity 115A; the second cavity 115B can also have a second impingement zone 120B thermally coupled to the second surface 112. Furthermore, a third cavity 115C can also be included in the body 100, illustrated in the example of FIG. 3 as being located aft of the second cavity 115B and forward of the first cavity 115A. The third cavity 115C can include a third impingement zone 120C, and can also be fluidly coupled to the inlet 106, e.g. via the first cavity 115A.

While not illustrated, the impingement zones 120A, 120B, 120C can also include surface features, such as projections, dimples, or irregular surface roughness, such that airflows that impinge the zones 120A, 120B, 120C can be directed toward any desired direction or broken up after impingement, in non-limiting examples. It should be understood that other features or structures not shown can also be utilized in the shroud 98.

In the example of FIG. 3, the first and third cavities 115A, 115C are fluidly coupled via a first connecting passage 121, and the second and third cavities 115B, 115C are fluidly coupled via a second connecting passage 122. Thus, in this manner a cooling circuit 125 can be at least partially defined by the inlet 106, first, second, and third cavities 115A, 115B, 115C, and connecting passages 121, 122. Further, it can be seen that at least a portion of the cooling circuit 125 can have a serpentine profile which can be partially formed by the shape or arrangement of the first, second, or third cavities 115A, 115B, 115C.

It can be appreciated that while three cavities are illustrated in the examples of FIG. 3, any number of cavities can be utilized within the body 100. For example, the first and second cavities 115A, 115B can be connected by a single connecting passage (not shown) to at least partially define the cooling circuit 125. The arrangement of the multiple cavities connected by multiple passages provides for the passages to enter the cavities such that they are generally oriented toward an impingement surface that the incoming cooling air can impinge for cooling and then disperse downstream to the next passage/cavity. Additionally, it is contemplated that various cooling circuits 125 can be arranged in parallel in the circumferential direction of the shroud 98.

A discharge passage 130 can be formed through the body 100, fluidly coupling the second cavity 115B to the fore edge 102 of the body 100. It is further contemplated that the discharge passage 130 can fluidly couple either the first cavity 115A or third cavity 115C to either the fore edge 102 or aft edge 104, or that a plurality of discharge passages 130 can be utilized to fluidly couple any desired cavity to the fore edge 102, the aft edge 104, or any side or circumferential edge (not shown in cross section), in non-limiting examples.

Additionally, and with continued reference to FIG. 3, at least one cooling passage can be provided in the body 100 to fluidly couple any or all of the first, second, and third cavities 115A, 115B, 115C to the second surface 112 that faces the heated fluid flow 110. More specifically, a first cooling passage 141 can fluidly couple the first cavity 115A to the second surface 112, and a second cooling passage 142 can fluidly couple the second cavity 115B to the second surface 112 forward of the first cooling passage 141. The third cavity 115C can also include a third cooling passage 143 fluidly coupling the third cavity 115C to the second surface 112 as shown.

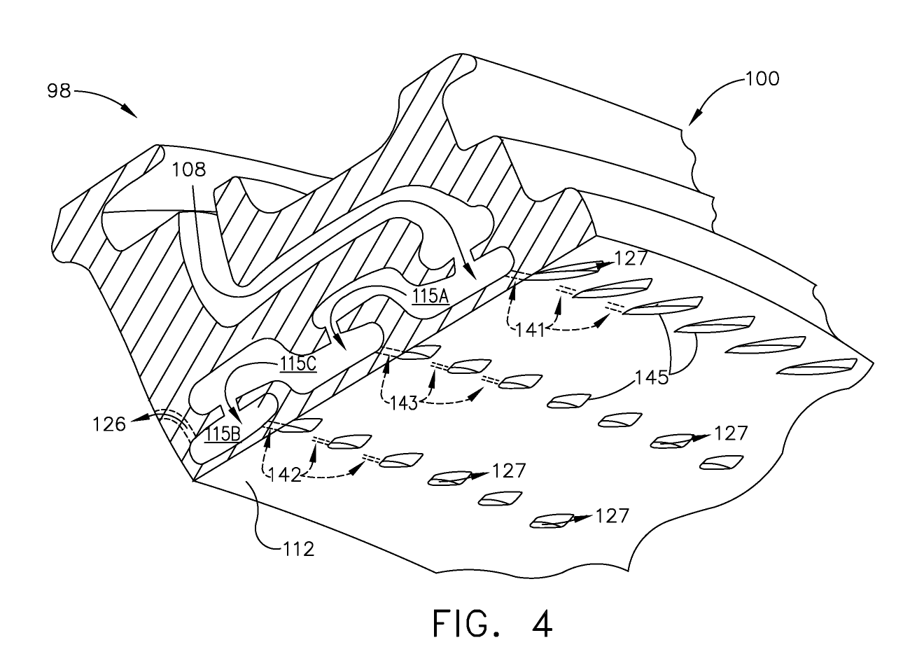

Turning to FIG. 4, the shroud 98 is illustrated in isolation with the second surface 112 shown in further detail. The first cooling passage 141 can include a plurality of first cooling passages 141 fluidly coupling the first cavity 115A to the second surface 112, Similarly, the second and third cooling passages 142, 143 can each include a plurality of second and third cooling passages 142, 143, respectively, that can fluidly couple the second and third cavities 115B, 115C to the second surface 112 as shown. At least one of the first, second, and third cooling passages 141, 142, 143 is illustrated with a curved or curvilinear centerline; it is further contemplated that the cooling passages 141, 142, 143 can also be straight or linear, or any other shape as desired for the environment of the shroud 98. Furthermore, at least one of the first, second, or third cooling passages 141, 142, 143 can include a diffuser 145 fluidly opening onto the second surface 112 as shown. It can be appreciated that the body 100 of the shroud 98 forms an annular component within the turbine engine 10, surrounding the stage 66 of FIG. 3. In this manner the plurality of first cooling passages 141 can be spaced apart in the circumferential direction and fluidly coupling the first cavity 115A to the second surface 112, including via diffusers 145. Similarly, the plurality of second cooling passages 142 and third cooling passages 143, respectively, can also be circumferentially spaced and include diffusers 145. In this manner the first, second, or third cooling passages 141, 142, 143 can be positioned annularly, in a circumferential direction, about the body 100 of the shroud 98. Additionally, the cooling passages 141, 142, and 143 can be angled to discharge cooling air in an optimal direction based on the axial engine location and the velocity of the blade 70 tip.

In operation, the cooling fluid flow 108 (FIG. 3, FIG. 4) can move through the inlet 106, where the cooling fluid flow 108 can be supplied by the hanger cooling circuit 25C (FIG. 3) or by any other desired component within the engine 10 (FIG. 1). The cooling fluid flow 108 can impinge the first impingement zone 120A (FIG. 3), thereby cooling the second surface 112 proximate the first impingement zone 120A. The cooling fluid flow 108 can move through the first connecting passage 121 (FIG. 3) and impinge the third impingement zone 120C, cooling the second surface 112 proximate the third impingement zone 120C, and can then impinge the second impingement zone 120B and cool the second surface proximate the second impingement zone 120B. A portion 126 (FIG. 3, FIG. 4) of the cooling fluid flow 108 can move out of the shroud 98 through the discharge passage 130 and purge any leakage flows 150 (FIG. 3) which may be flowing along the fore edge 102 of the body 100 such as combustion gases (not shown) moving through the engine 10. A cooling portion 127 (FIG. 3, FIG. 4) of the cooling fluid flow 108 can also move out of the shroud 98, including through the first, second, or third cooling passages 141, 142, 143, and diffusers 145 (FIG. 4), to cool the second surface 112 from its thermal contact with the heated fluid flow 110 (FIG. 3). Furthermore, it should be understood that aspects of the shroud 98 as described herein can be utilized in any shroud within the engine 10 as desired, including a shroud that does not form part of a shroud and hanger assembly.

A method of purging the leakage flow 150 in the turbine engine 10 includes serially flowing cooling air, e.g. the cooling fluid flow 108 (FIG. 3), through multiple impingement cavities including the first and second cavities 115A, 115B adjacent the heated second surface 112. At least some of the cooling air, such as the portion 126 (FIG. 3), can be exhausted from the impingement first or second cavities 115A, 115B, to purge the leakage flow 150 along an edge of the body 100, including the fore edge 102 or aft edge 104. The cooling portion 127 of cooling fluid flow 108 can also be exhausted through cooling holes, including the first or second cooling passages 141, 142, fluidly coupling the impingement first and second cavities 115A, 115B to the heated second surface 112. Furthermore, each impingement first and second cavity 115A, 115B can include an impingement zone, such as the first and second impingement zones 120A, 120B, thermally coupled to the heated second surface 112 as illustrated at least in FIG. 3.

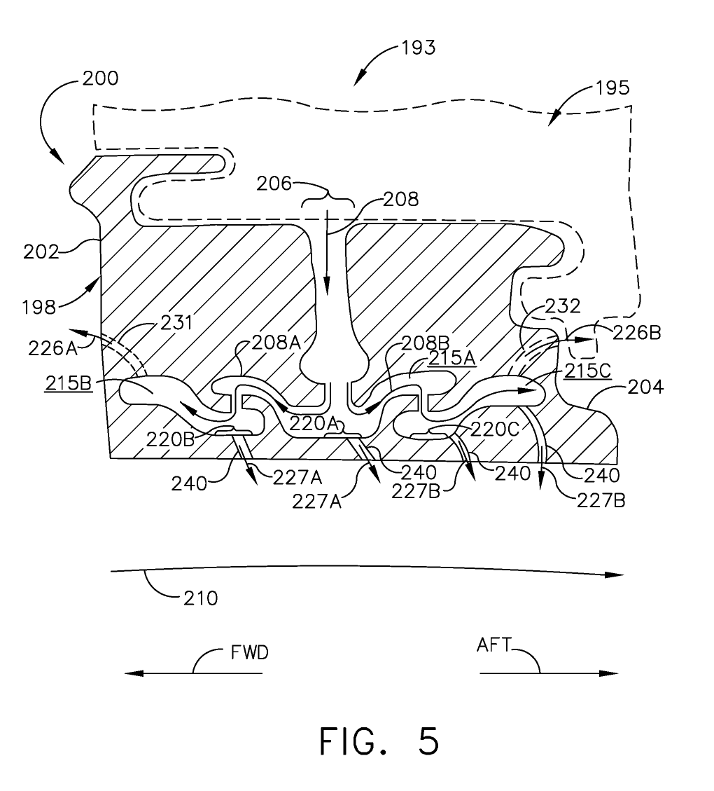

Referring now to FIG. 5, another shroud and hanger assembly 193 is illustrated which can be utilized in the turbine engine 10 of FIG. 1. The shroud and hanger assembly 193 is similar to the shroud and hanger assembly 93; therefore, like parts will be identified with like numerals increased by 100, with it being understood that the description of the like parts of the assembly 93 applies to the assembly 193, unless otherwise noted.

The shroud and hanger assembly 193 includes a hanger 196 which is illustrated in phantom for clarity, as well as a shroud 198 having a body 200 with a fore edge 202, an aft edge 204, a first surface 211 with an inlet 206 fluidly coupled to a cooling fluid flow 208, and a second surface 212 spaced radially inward from the first surface 211 and facing a heated fluid flow 210. It should be understood that aspects of the shroud 198 as described herein can be utilized in any shroud within the engine 10 as desired, including a shroud that does not form part of a shroud and hanger assembly.

The body 200 includes a first cavity 215A fluidly coupled to the inlet 206 and having a first impingement zone 220A, where the first cavity 215A is located in a central position within the body 200 of the shroud 198. A second cavity 215B having a second impingement zone 220B is fluidly coupled to the first cavity 215A via a first connecting passage 221 located forward of the first cavity 215A. A third cavity 215C having a third impingement zone 220C can also be fluidly coupled to the first cavity 215A via a second connecting passage 222 located aft of the first cavity 215A as shown. A first discharge passage 231 can fluidly couple the second cavity 215A to the fore edge 202, and a second discharge passage 232 can fluidly couple the third cavity 215C to the aft edge 204.

In operation, the cooling fluid flow 208 can move into the first cavity 215A and impinge the first impingement zone 220A. The cooling fluid flow 208 can be divided into first and second portions 208A, 208B that move into the respective second and third cavities 215B, 215C and impinge their respective impingement zones 220B, 220C. The first portion 208A can be further divided into a cooling portion 227A that flows out to the second surface 212 via first or second cooling passages 241, 242 in the first or second cavities 215A, 215B, as well as a discharge portion 226A that flows out to the fore edge 202 via the first discharge passage 231. The second portion 208B can also be further divided into a second cooling portion 227B that flows out to the second surface 212 via first or third cooling passages 241, 243, as well as a second discharge portion 226B that flows out of the body 200 to the aft edge 204 via the second discharge passage 232.

The present disclosure provides for a variety of benefits, including that directing the cooling air through multiple impingements can provide for improved cooling effectiveness of the shroud, including the heated surface facing the heated air flow. In addition, reusing the impinged cooling air to purge leakage flows can provide for improved cooling effectiveness and lower amounts of supplied air to the inlet, compared to traditional shrouds with separate air supplies for each function. In addition, the use of curved cooling passages within the impingement cavities can provide for more stable diffusion through the passages, as well as increased bore cooling with the increased amount of material removed for the curved cooling passages, and also more persistent air film along the heated second surface of the shroud body.

It can also be appreciated that the increased cooling of the shroud and reduced need of supplied bleed air can also increase the engine efficiency, including improved specific fuel consumption of the turbine engine.

It should be appreciated that application of the disclosed design is not limited to turbine engines with fan and booster sections, but is applicable to turbojets and turbo engines as well.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A shroud for a turbine engine comprising:
a body having a first edge, a second edge, a first surface with an inlet fluidly coupled to a cooling fluid flow, and a second surface spaced radially inward from the first surface and facing a heated fluid flow;
a first cavity within the body fluidly coupled to the inlet and having a first impingement zone thermally coupled to the second surface;
a second cavity within the body fluidly coupled to the first cavity and having a second impingement zone thermally coupled to the second surface;
a cooling passage fluidly coupling one of the first and second cavities to the second surface; and
a discharge passage fluidly coupling one of the first and second cavities to one of the first edge and second edge.

2. The shroud of claim 1 wherein the first and second cavities are fluidly coupled by a connecting passage to at least partially define a cooling circuit.

3. The shroud of claim 2 wherein at least a portion of the cooling circuit has a serpentine profile.

4. The shroud of claim 1 further comprising a first cooling passage fluidly coupling the first cavity to the second surface, and a second cooling passage fluidly coupling the second cavity to the second surface.

5. The shroud of claim 4 wherein the second cooling passage is forward of the first cooling passage.

6. The shroud of claim 1 further comprising a plurality of cooling passages spaced in a circumferential direction within at least one of the first cavity and the second cavity.

7. The shroud of claim 6 wherein the cooling passages are curved.

8. The shroud of claim 1 wherein the cooling passage further comprises a diffuser fluidly opening onto the second surface.

9. The shroud of claim 1 further comprising a third cavity fluidly coupled to the inlet and having a third impingement zone thermally coupled to the second surface.

10. The shroud of claim 9 wherein the third cavity is aft of the second cavity.

11. The shroud of claim 9 wherein the third cavity is forward of the first cavity.

12. A shroud and hanger assembly for a turbine engine comprising:
a hanger comprising a hanger cooling circuit with a circuit inlet and a circuit outlet, the circuit inlet being fluidly coupled to a cooling fluid flow; and
a shroud comprising:
a body having a first edge, a second edge, a first surface with an inlet fluidly coupled to the circuit outlet, and a second surface spaced radially inward from the first surface and facing a heated fluid flow;
a first cavity within the body fluidly coupled to the inlet and having a first impingement zone thermally coupled to the second surface;
a second cavity within the body fluidly coupled to the first cavity and having a second impingement zone thermally coupled to the second surface;
a cooling passage fluidly coupling one of the first and second cavities to the second surface; and
a discharge passage fluidly coupling one of the first and second cavities to one of the first edge and second edge.

13. The shroud and hanger assembly of claim 12 wherein the first and second cavities are fluidly coupled by a connecting passage to at least partially define a cooling circuit.

14. The shroud and hanger assembly of claim 13 wherein at least a portion of the cooling circuit has a serpentine profile.

15. The shroud and hanger assembly of claim 12 further comprising a plurality of cooling passages spaced in a circumferential direction within at least one of the first cavity and the second cavity.

16. A turbine engine comprising a compressor section, a combustor, and a turbine section in axial flow arrangement, at least one of the compressor section or the turbine section comprising a stage having an airfoil assembly with a shroud, the shroud comprising:
a body having a first edge, a second edge, a first surface with an inlet fluidly coupled to a cooling fluid flow, and a second surface spaced radially inward from the first surface and facing a heated fluid flow;
a first cavity within the body fluidly coupled to the inlet and having a first impingement zone thermally coupled to the second surface;
a second cavity within the body fluidly coupled to the first cavity and having a second impingement zone thermally coupled to the second surface;
a cooling passage fluidly coupling one of the first and second cavities to the second surface; and
a discharge passage fluidly coupling one of the first and second cavities to one of the first edge and second edge.

17. The turbine engine of claim 16 wherein the first and second cavities are fluidly coupled by a connecting passage to at least partially define a cooling circuit.

18. The turbine engine of claim 17 wherein at least a portion of the cooling circuit has a serpentine profile.

19. The turbine engine of claim 16 further comprising a first cooling passage fluidly coupling the first cavity to the second surface, and a second cooling passage fluidly coupling the second cavity to the second surface.

20. The turbine engine of claim 19 wherein the second cooling passage is forward of the first cooling passage.

21. The turbine engine of claim 16 further comprising a plurality of cooling passages spaced in a circumferential direction within at least one of the first cavity and the second cavity.

22. The turbine engine of claim 21 wherein the cooling passages are curved.

23. The turbine engine of claim 16 wherein the cooling passage further comprises a diffuser fluidly opening onto the second surface.

24. The turbine engine of claim 16 further comprising a third cavity fluidly coupled to the inlet and having a third impingement zone thermally coupled to the second surface.

25. The turbine engine of claim 24 wherein the third cavity is aft of the second cavity.

26. The turbine engine of claim 25 wherein the third cavity is forward of the first cavity.

27. A method of purging a leakage flow in a turbine engine comprising a shroud including a body having a first surface with an inlet fluidly coupled to a cooling fluid source and a heated second surface facing a heated fluid flow, the method comprising:
serially flowing cooling air through multiple impingement cavities adjacent the heated second surface; and
exhausting at least some of the cooling air from the impingement cavities to purge a leakage flow along an edge of the body.

28. The method of claim 27 further comprising exhausting cooling air through cooling holes fluidly coupling the impingement cavities to the heated second surface.

29. The method of claim 27 wherein each impingement cavity includes an impingement zone thermally coupled to the heated second surface.
